(19) United States
(12) Patent Application Publication
(10) Pub. No.: US 2012/0204248 A1
(43) Pub. Date: Aug. 9, 2012

(54) PROVISIONER FOR SINGLE SIGN-ON AND NON-SINGLE SIGN-ON SITES, APPLICATIONS, SYSTEMS, AND SESSIONS

(75) Inventors: Christopher M. Gonzalez, Saint Petersburgh, FL (US); S. A. Vetha Manickam, Chennai (IN); Ramanjaneyulu Padegal, Adoni (IN); Dinyar Kavouspour, Plano, TX (US); James Carleton Hicks, Keller, TX (US); Venkata Ramana Murthy Poludasu, Lewisville, TX (US)

(73) Assignee: VERIZON PATENT AND LICENSING INC., Basking Ridge, NJ (US)

(21) Appl. No.: 13/023,874

(22) Filed: Feb. 9, 2011

(51) Int. Cl. H04L 9/32

(52) U.S. Cl. 726/8

(57) ABSTRACT

A method including receiving an access request to a provisioning system; determining whether to grant access based on receipt of one or more user credentials; determining a level of access to the provisioning system based on user role information, when the one or more user credentials are valid; receiving configuration information by the provisioning system that permits a user to configure an automated sign-on system for single sign-on sites, non-single sign-on sites, mainframe sessions and applications, systems, and user device applications; and configuring the automated sign-on system based on the received configuration information.

### BACKGROUND

Network providers may provide single sign-on services to users so that users may access multiple web sites based on a single log-on.

### BRIEF DESCRIPTION OF THE DRAWINGS

FIG. 1A is a diagram illustrating an exemplary embodiment of an environment that includes a user-access provisioning device for provisioning automated sign-on to sites, sessions, systems, and applications;

FIGS. 1B-1F are diagrams illustrating an exemplary process for signing into a user access provisioning device to provision automated sign-on to sites, sessions, systems, and applications;

FIG. 2 is a diagram illustrating exemplary components of a device that may correspond to one or more of the devices in environment;

FIG. 3 is a diagram illustrating an exemplary environment to provision automated sign-on to sites, sessions, systems, and applications; and

FIG. 4 is a flow diagram illustrating an exemplary process for signing into and provisioning sites, sessions, systems, and applications.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

The term “network,” as used herein, is intended to be broadly interpreted to include a wireless network (e.g., mobile network, cellular network, non-cellular network, etc.) and/or a wired network. By way of example, the network may include the Internet, an intranet, a wide area network, a local area network, a private network, a public network, an enterprise network, etc. In this regard, the embodiments described herein may be implemented within a variety of network types.

According to exemplary embodiments, a network may include a user-access provisioning device that integrates credential management with various types of resources that may be available to users via a sign-on system. For example, the sign-on system may permit users to access and use various sites, sessions, and applications, as well as provide an automated sign-on (e.g., login) to these sites, sessions, systems, and applications. According to an exemplary embodiment, the user-access provisioning device may permit users to provision processes pertaining to the automated signing into the sites, sessions, systems, and applications. By way of example, the user-access provisioning device may permit users to provision automated processes pertaining to the logging into single-sign on (SSO) protected sites (e.g., Netegrity protected sites, web sites, company or proprietary sites, intranet sites, Internet sites, etc.), non-SSO protected sites (e.g., non-Netegrity protected sites, web sites, proprietary sites, Intranet sites, Internet sites, etc.), mainframe sessions and applications (e.g., Hummingbird and Attachmate mainframe sessions, applications), systems (e.g., network devices (e.g., a server, a switch, a router, a Universal Serial Bus (USB) device, a meter, etc.), user devices (e.g., a terminal, a television and set top box, a mobile device, a handheld device, a stationary device, or some other access platform, etc.)), and other types of applications (e.g., desktop applications, Windows Forms-based applications, line-of-business (LOB) applications (e.g., department-based applications, company-based applications, etc.), common applications (e.g., applications available to all LOBs, applications available to all users, etc.)).

According to an exemplary embodiment, the user-access provisioning device may include a provisioning portal. The provisioning portal may correspond to a web-portal or some other type of network-based portal. The provisioning portal may provide user interfaces (e.g., graphical user interfaces, text-based interfaces, command line interfaces, and/or window-based interfaces) to allow users to provision and use the functions offered. For example, the provisioning portal may permit a user to create a user or a user group (e.g., including multiple users) and manage the user or the user group with respect to sites, sessions, systems, and applications available to such user or user group of the sign-on system. Additionally, the provisioning portal may permit the user to manage user profile information, user roles, and network and user device configurations. In addition to these tasks, the provisioning portal may permit users to perform other tasks, which are described elsewhere in this description.

According to an exemplary embodiment, the provisioning portal may provide various functions to users based on user roles, which may be assigned to users via the provisioning portal. For example, within an enterprise or business setting, users may be assigned different user roles that offer different privileges pertaining to the provisioning portal. By way of example, users may be assigned an administrative user role, a LOB administrative user role, a self-managed user role, or a managed user role. According to other implementations, different types of user roles and/or provisioning privileges than those described herein may be implemented.

An administrative user may be allowed, via the provisioning portal, to create, modify, and delete users, user membership in groups, and groups. For example, the administrator user may create, modify, and delete a user(s), user(s) of a group, and a group(s) that use the sign-on system. Additionally, the administrative user may be allowed to create, modify, add, and delete sites, sessions, systems, and applications assigned to users, users of a group, and groups that the users, users of the group, and groups may be authorized to access and use via the sign-on system. For example, the administrative user may be allowed to create and modify sign-on processes pertaining to the access and use of sites, sessions, systems, and applications, which may include processes pertaining to the population of credential information in particular fields during a sign-on process, location of applications (e.g., path information, name of application executable files, name of applications, etc.), network addresses (e.g., Uniform Resource Identifiers (URIs), Uniform Resource Locators (URLs), Media Access Control (MAC) address, etc.). The administrative user may be allowed to add and delete sites, sessions, and applications available to users via the sign-on system. The administrative user may be allowed to manage user roles and user profiles. For example, user profile information may include user identifier information (e.g., name, company identifier, department identifier, device identifier); sites, sessions, systems, and applications the user is authorized to access and use; credential information (e.g. password information, user identifier, etc.) pertaining to the sign-on to sites, sessions, systems, and applications; membership in groups; default page(s), user preferences, etc.

The administrative user may also be allowed to create, modify, and delete environmental configurations pertaining to the user-access provisioning device (e.g., the provisioning portal). For example, the administrative user may have access to a developing environment, a testing environment, a staging environment (e.g. for final checks), and a production environment that allows the administrative user to develop, test, and put into production functions and/or processes provided by the user-access provisioning device. Similarly, the administrative user may be allowed to create, modify, and delete environmental configurations pertaining to the sign-on system. For example, the sign-on system may include an application (e.g., a client application or a peer application, such as a toolbar or other GUI) that permits users to access and use the sign-on system via their user devices. The administrative user may have access to a developing environment, a testing environment, a staging environment, and a production environment that allows the administrative user to develop, test, and put into production functions and/or processes provided by the application.

The administrative user may be allowed to view log information pertaining to the usage of the sites, sessions, systems, and applications, the user-access provisioning device, the client or the peer application, and sign-on system devices. Also, the administrative user may be allowed to create, modify, and delete site messages (e.g., website messages or other type of network site messages) and client or peer application information (e.g., pertaining to sign-on processes).

Additionally, the administrative user may be allowed to approve, modify, and delete user-requested sites, sessions, systems, and applications. The administrative user may be allowed to submit feedback forms pertaining to the sign-on system and the user-access provisioning device, and view submitted feedback forms. The administrative user may also be allowed to create, modify, and delete help desk information that may assist users in accessing and using the sign-on system and the user-access provisioning device.

An LOB administrative user may be allowed, via the provisioning portal, to create, modify, and delete users, user membership in groups, and groups pertaining to a particular LOB (e.g., department, company, organization, or other segment of a business, etc.); create, modify, and delete sites, sessions, systems, and applications assigned to users, users of a group, and groups that the users, users of the group, and groups may be authorized to access and use of a particular LOB; manage existing user roles pertaining to a particular LOB; approve, modify, and delete user-requested sites, sessions, systems, and applications pertaining to a particular LOB; modify user profiles of a particular LOB; submit feedback forms; and view submitted feedback forms from users of a particular LOB.

A self-managed user may be allowed, via the provisioning portal, to assign sites, sessions, systems, and applications to his/her user profile; request new sites, sessions, and applications to be added to the sign-on system; view the status of requested sites, sessions, systems, and applications; and submit feedback forms. A managed user may not be afforded provisioning privileges. Rather, the managed user may only be able to submit feedback forms via the provisioning portal.

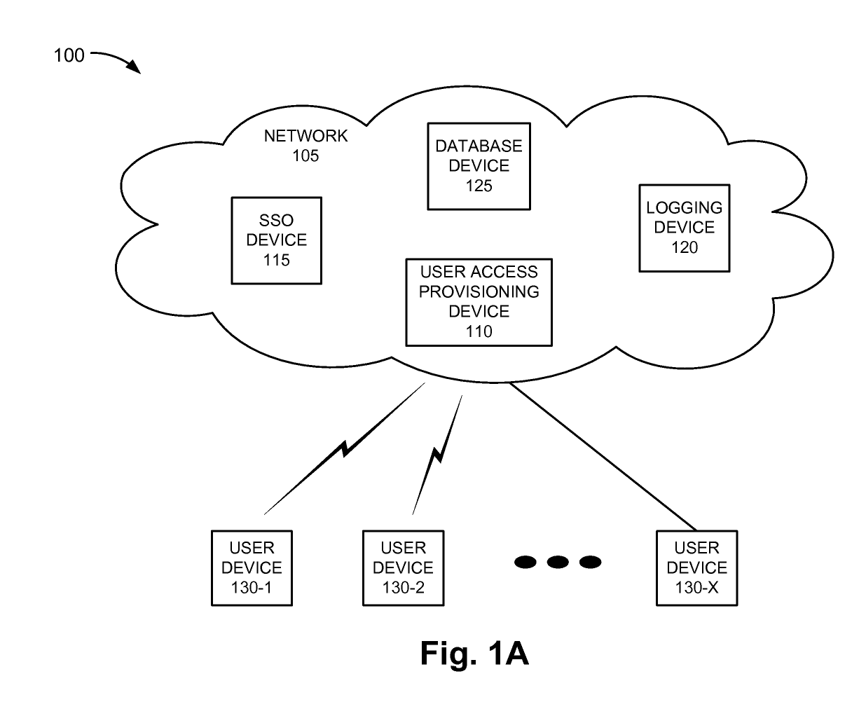

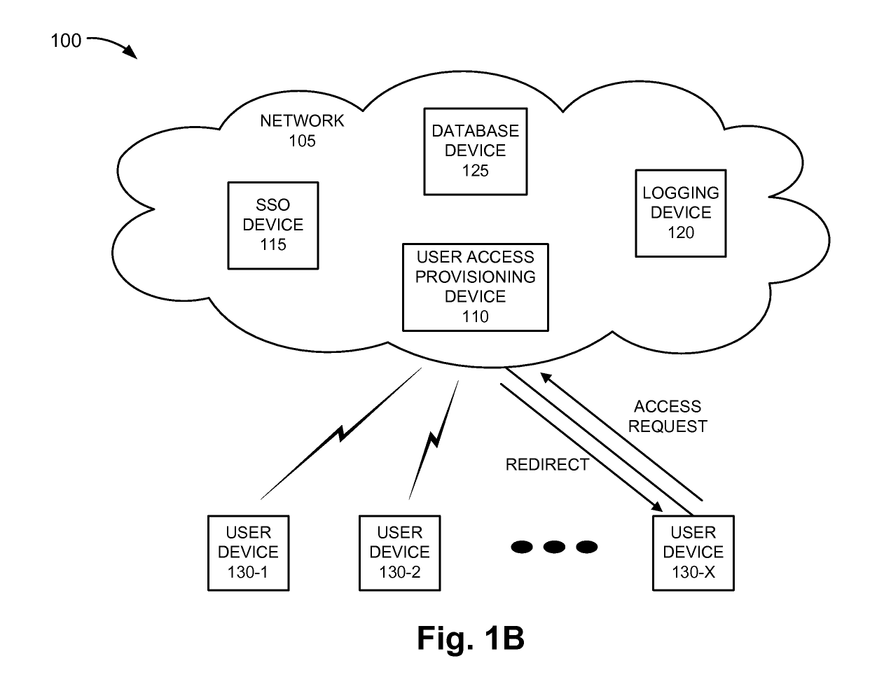

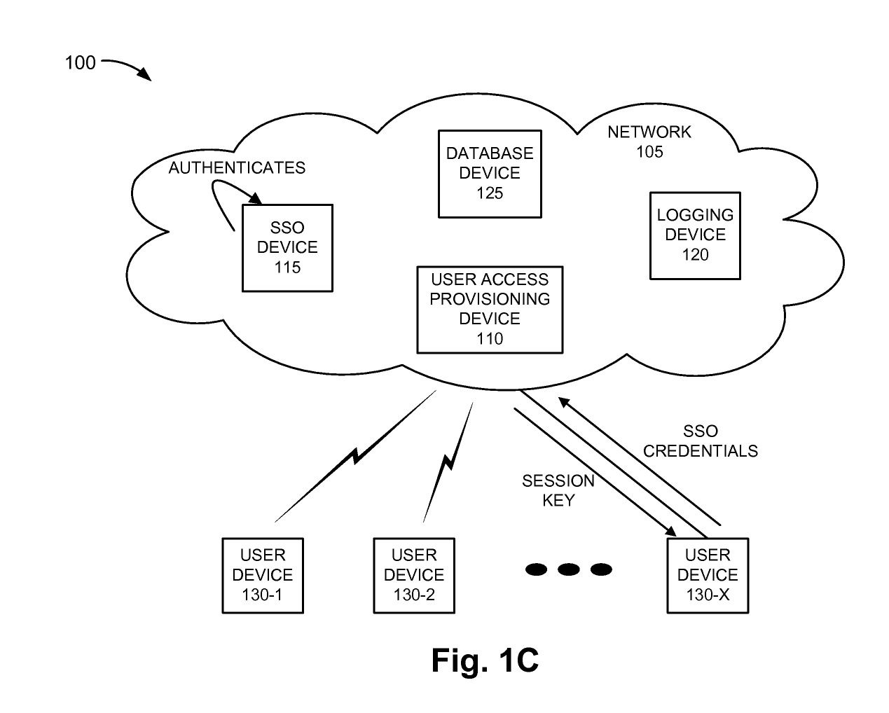

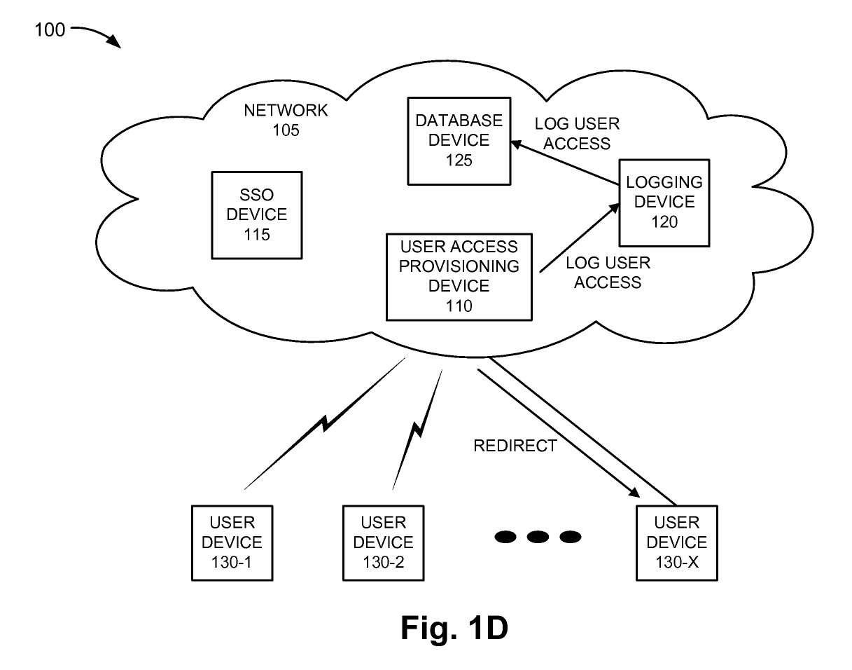

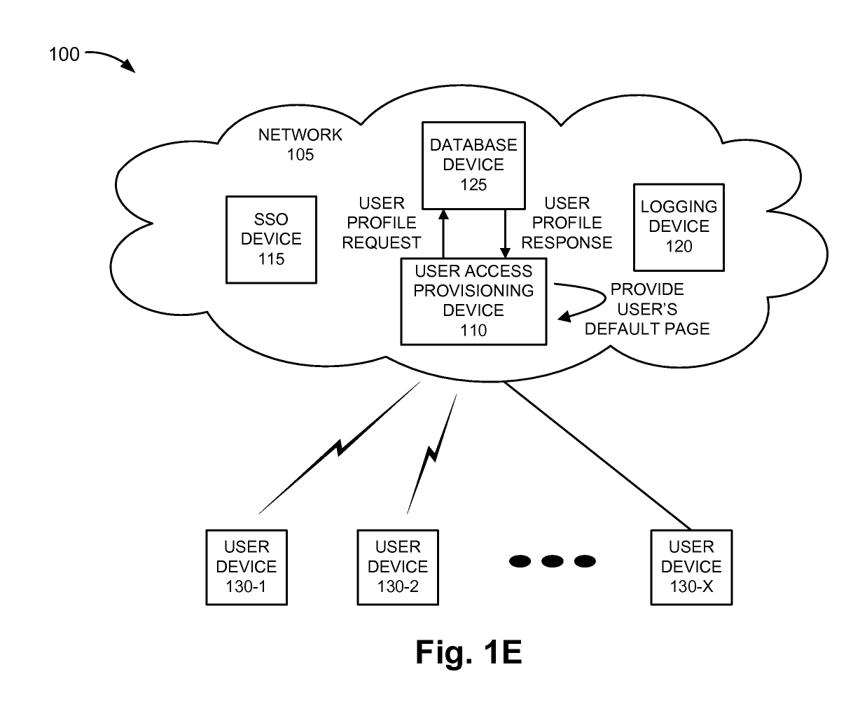

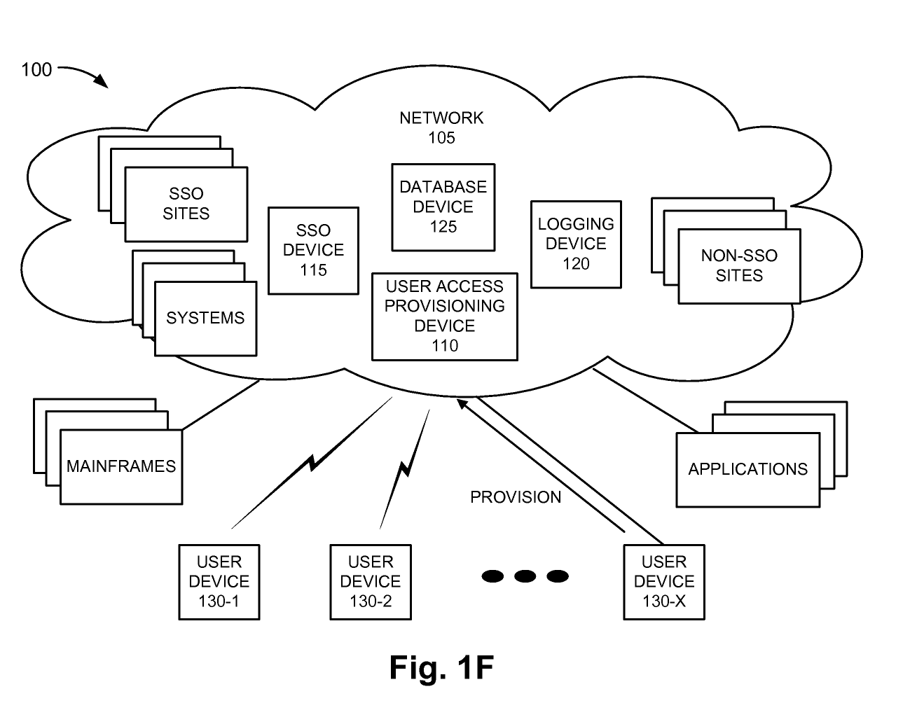

FIG. 1A is a diagram illustrating an exemplary embodiment of an environment 100 that includes a user-access provisioning device for provisioning automated sign-on to sites, sessions, systems, and applications. As illustrated, exemplary environment 100 may include network 105 including a user access provisioning device 110, an SSO device 115, a logging device 120, a database device 125, and user devices 130-1 through 130-X (referred to as user devices 130 or user device 130).

The number of devices and configuration in environment 100 is exemplary and provided for simplicity. In practice, environment 100 may include additional devices, fewer devices, different devices, and/or differently arranged devices than those illustrated in FIG. 1A. Also, according to other embodiments, one or more functions and/or processes described as being performed by a particular device in environment 100 may be performed by a different device or multiple devices. Additionally, or alternatively, one or more functions and/or processes described as being performed by multiple devices may be performed by different devices or a single device.

Although FIG. 1A illustrates separate instances of user access provisioning device 110, SSO device 115, logging device 120, and database device 125, according to other embodiments, two or more of these devices may be combined. For example, user access provisioning device 110 and logging device 120 may be combined, or logging device 120 and database device 125 may be combined, etc. Environment 100 may include wired and/or wireless connections among the devices illustrated.

Network 105 may include one or multiple networks of one or multiple types. User access provisioning device 110 may include a network device that permits users to provision processes pertaining to the automated signing into sites, sessions, systems, and applications, as described herein. As an example, user access provisioning device 110 may be implemented by a server (e.g., a web server or some other type of network server) or a peer device.

SSO device 115 may include a network device that provides single sign-on services. According to an exemplary embodiment, SSO device 115 may provide single sign-on services pertaining to the access and use of web sites, web applications, network sites, and/or network-based applications. As an example, SSO device 115 may be implemented by a server (e.g., a web server, a proxy server, etc.), an access point, a security device, or a gateway device.

Logging device 120 may include a network device that logs user access information with database device 125. As an example, logging device 120 may be implemented by a server (e.g., a web server, a proxy server, etc.) or some other type of network computer.

Database device 125 may include a network device that stores user profile information. The user profile information may include, for example, one or multiple user identifiers (e.g., user name, company identifier, department identifier, etc.), user credential information (e.g., password information, user identifier, etc.) pertaining to the sign-on to sites, sessions, systems, and applications, membership in groups, default page(s), user preferences, sign-on information (e.g., path to applications, URIs, URLs, etc.), user role information, etc. As an example, database device 125 may be implemented by a server (e.g., a database server, a web server, etc.), a computational device (e.g., a network computer, etc.), or some other type of repository device.

User device 130 may include a device having the capability to communicate with other devices, systems, networks, and/or the like. In practice, user device 130 may correspond to a stationary device, a portable device, a handheld device, a mobile device, a vehicle-based device, or some other type of user device. As an example, user device 130 may correspond to a wireless telephone, a computer (e.g., a desktop, a laptop, a palmtop, a netbook, a tablet, etc.), a personal digital assistant (PDA), or a personal communication system (PCS) terminal. User device 130 may operate according to one or multiple communication standards, protocols, etc. User device 130 may communicate via a wireless connection and/or via a wired connection.

FIGS. 1B-1F are diagrams illustrating an exemplary process for signing into user access provisioning device 110 to provision automated sign-on to sites, sessions, systems, and applications. In this example, user access provisioning device 110 may correspond to a single sign-on site. According to other embodiments, user access provisioning device 110 may correspond to a non-single sign-on site.

Referring to FIG. 1B, in this example, a user may send an access request, via user device 130-X, to user access provisioning device 110. For example, the user may enter a URL of user access provisioning device 110 into a web browser. User access provisioning device 110 may redirect the user to SSO device 115. As illustrated in FIG. 1C, the user may provide his/her SSO credentials (e.g., a user identifier, password, etc.) to SSO device 115. SSO device 115 may authenticate the user based on the SSO credentials. In this example, it may be assumed that SSO device 115 successfully authenticates the user. Upon successful authentication, SSO device 115 may send the user a session key. The session key may include user access information, such as, for example, a user access provisioning device identifier, a level of access (e.g., user role), and a timestamp (e.g., date, time, etc.).

Referring to FIG. 1D, SSO device 115 may redirect the user to user access provisioning device 110. User access provisioning device 110 may send the user access information to logging device 120 to have the user's access logged-in with database device 125. Logging device 120 may manage, among other things, availability and queueing issues pertaining to the storing of the user access information by database device 125. Logging device 120 may send the user access information to database device 125, and the user access information may be stored by database device 125.

Referring to FIG. 1E, user access provisioning device 110 may send a user profile request for the user's profile to database device 125. The user profile request may include the user's access provisioning device identifier. Database device 125 may access a database that stores user profile information and retrieve the user's profile based on the user's access provisioning device identifier. Database device 125 may send a user profile response to user access provisioning device 110. The user profile response may include the retrieved user's profile. Based on the user profile information, user access provisioning device 110 may provide the user with a default page to begin provisioning. As illustrated in FIG. 1F, the user may provision sites, sessions, systems, and applications via user access provisioning device 110.

In view of the foregoing, the user may provision, via user access provisioning device 110, automated processes pertaining to the signing-on to sites, sessions, systems, and applications available to users.

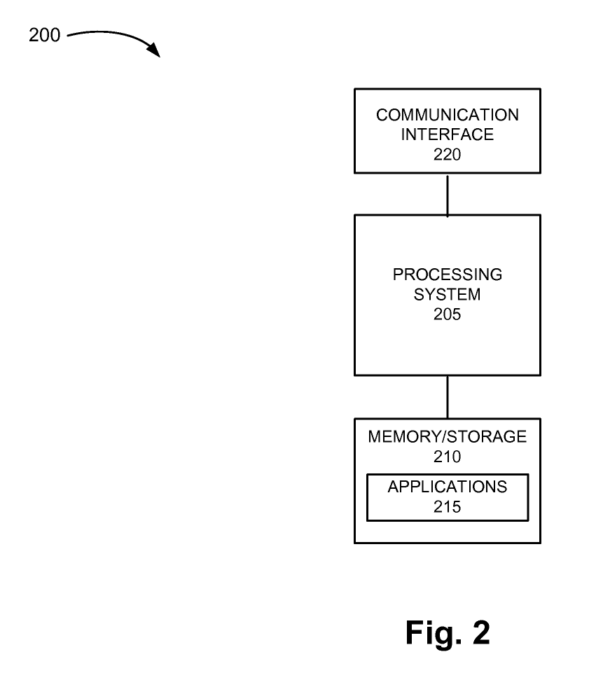

FIG. 2 is a diagram illustrating exemplary components of a device 200 that may correspond to one or more of the devices in environment 100. For example, device 200 may correspond to user access provisioning device 110, SSO device 115, logging device 120, database device 125, and/or user device 130, depicted in FIG. 1A. As illustrated, device 200 may include a processing system 205, memory/storage 210 including applications 215, and a communication interface 220. According to other implementations, device 200 may include fewer components, additional components, different components, and/or a different arrangement of components than those illustrated in FIG. 2 and described herein. For example, device 200 may include input components (e.g., a display, a keyboard, a keypad, a microphone, an input port, etc.) and output components (e.g., a display, a speaker, an output port, etc.).

Processing system 205 may include one or multiple processors, microprocessors, data processors, co-processors, application specific integrated circuits (ASICs), controllers, programmable logic devices, chipsets, field programmable gate arrays (FPGAs), or some other component that may interpret and/or execute instructions and/or data. Processing system 205 may control the overall operation, or a portion of operation(s) performed by device 200. Processing system 205 may perform one or multiple operations based on an operating system and/or various applications (e.g., applications 215). Processing system 205 may access instructions from memory/storage 210, from other components of device 200, and/or from a source external to device 200 (e.g., another device, a network, etc.).

Memory/storage 210 may include one or multiple memories and/or one or multiple secondary storages. For example, memory/storage 210 may include a random access memory (RAM), a dynamic random access memory (DRAM), a read only memory (ROM), a programmable read only memory (PROM), a flash memory, and/or some other type of storing medium (e.g., a computer-readable medium, a compact disk (CD), a digital versatile disk (DVD), or the like). Memory/storage 210 may include a hard disk (e.g., a magnetic disk, an optical disk, a magneto-optic disk, a solid state disk, etc.) or some other type of medium, along with a corresponding drive. Memory/storage 210 may be external to and/or removable from device 200, such as, for example, a Universal Serial Bus (USB) memory stick, a dongle, a hard disk, mass storage, off-line storage, or the like.

The term “computer-readable medium,” as used herein, is intended to be broadly interpreted to include, for example, a memory, a secondary storage, a CD, a DVD, or another type of tangible storage medium. Memory/storage 210 may store data, application(s), and/or instructions related to the operation of device 200.

Applications 215 may include software that provides various services or functions. For example, applications 215 may include applications that perform various network-related and/or communication-related functions. According to an exemplary embodiment, applications 215 may include one or multiple applications to implement the provisioning of automated sign-on to sites, sessions, systems, and applications, as described herein.

Communication interface 220 may permit device 200 to communicate with other devices, networks, systems and/or the like. Communication interface 220 may include one or multiple wireless interfaces and/or wired interfaces. Communication interface 220 may include one or multiple transmitters, receivers, and/or transceivers. Depending on the network, communication interface 220 may include interfaces according to one or multiple communication standards.

Device 200 may perform operations in response to processing system 205 executing software instructions stored by memory/storage 210. For example, the software instructions may be read into memory/storage 210 from another memory/storage 210 or from another device via communication interface 220. The software instructions stored in memory/storage 210 may cause processing system 205 to perform processes described herein. Alternatively, according to another implementation, device 200 may perform processes based on the execution of hardware (e.g., processing system 205, etc.), the execution of hardware and firmware, or the execution of hardware, software (e.g., applications 215), and firmware.

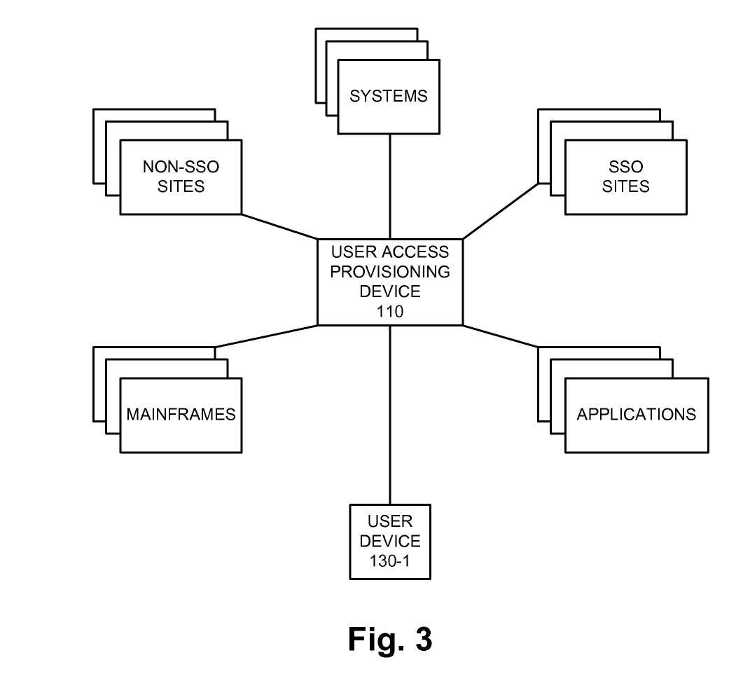

FIG. 3 is a diagram illustrating an exemplary environment to provision automated sign-on to sites, sessions, systems, and applications. As previously described, according to exemplary embodiments, user access provisioning device 110 may permit users to provision automated processes pertaining to logging into SSO protected sites, non-SSO protected sites, mainframe sessions and applications, systems, and other types of applications (e.g., desktop applications, Windows Forms-based applications, LOB applications (e.g., department-based applications, company-based applications, etc.), common applications (e.g., applications available to all LOBs, applications available to all users, etc.)).

According to an exemplary embodiment, user access provisioning device 110 may permit a user to manage the registration of SSO sites, non-SSO sites, mainframe sessions and applications, systems, as well as other types of applications. According to such an embodiment, users of the sign-on system may be provided with the automated sign-on to sites, sessions, systems, and applications service for those sites, sessions, systems, and applications that have been registered with user access provisioning device 110. User access provisioning device 110 may permit the user to provision the determination of whether a site, a session, a system, and an application is registered.

According to an exemplary embodiment, the provisioning of credentials pertaining to the automated sign-on to sites, sessions, systems, and applications may be divided into categories. For example, single credentials may include credentials that may be used to sign-on to a single site, session, system, or application and group credentials may include credentials that may be used to sign-on to multiple sites, sessions, systems, and/or applications. According to other exemplary embodiments, credentials may be divided into additional and/or different categories than those set forth herein. User access provisioning device 110 may permit the user to assign a particular category of credentials required by a site, session, system, and application, as well as user(s).

According to an exemplary embodiment, user access provisioning device 110 may provide multiple environments pertaining to the testing, production, and management of processes pertaining to the sign-on system and automated sign-on processes. These environments may be presented to the user via various user interfaces. As previously described, the provisioning portal may include, for example, a developing environment, a testing environment, a staging environment (e.g. for final checks), and a production environment. According to other embodiments, the provisioning portal may include additional, fewer, and/or different environments.

With reference to non-SSO sites, user access provisioning device 110 may permit the user to configure non-SSO sign-on processes and information pertaining to the automated sign-on to non-SSO sites. By way of example, the non-SSO sign-on processes and information may include a network address (e.g., a URI, a URL, etc.) associated with the non-SSO site, type of credential needed to access and use the non-SSO site (e.g., single credential, group credential, etc.), user interfaces for obtaining credentials from a user (e.g., a first time user may be prompted to provide credentials when attempting to access a non-SSO site), automatically launching an application (e.g., a web browser or other application), accessing the non-SSO site (e.g., provide the network address), finding credential fields associated with the non-SSO site (which may include automated navigation), populating credential fields with the credentials, submitting the credentials (e.g., automating the pressing of a submit button, an enter key, etc.) to the non-SSO site, and other information pertaining to the processing of other events (e.g., pop-ups, etc.) that may occur during a sign-on process for a particular non-SSO site. With reference to SSO sites, user access provisioning device 110 may permit the user to configure SSO sign-on processes and information pertaining to the automated sign-on to SSO sites. By way of example, the SSO sign-on processes and information may include processes and information analogous to those described for non-SSO sign-on sites.

With reference to mainframe sessions and applications, user access provisioning device 110 may permit the user to configure mainframe sign-on processes and information pertaining to the automated sign-on to mainframe sessions and applications. By way of example, the mainframe sign-on processes and information may include type of credential needed to access and use the mainframe (e.g., single credential, group credential, etc.), user interfaces for obtaining credentials from a user (e.g., a first time user may be prompted to provide credentials when attempting to access a mainframe or application), information pertaining to the type of connection needed (e.g., a Hummingbird connection, an Attachmate connection, etc.), information pertaining to the automation of establishing a connection (e.g., terminal mode information, Telnet connection information, Secure Shell (SSH) connection, Secure Sockets Layer (SSL) information, etc.), populating credential fields with the credentials, location of a mainframe application, and launching of the mainframe application.

With reference to systems, user access provisioning device 110 may permit the user to configure system sign-on processes and information pertaining to the automated sign-on to a system. By way of example, the system sign-on process and information may include a network address, type of credential needed to access and use the system, information pertaining to the type of connection needed, populating credential fields with the credentials, user interfaces for obtaining credentials from a user, submitting the credentials, location of a system application, and launching of the system application.

With reference to applications, user access provisioning device 110 may permit the user to configure application sign-on processes and information pertaining to the automated sign-on to applications. By way of example, the application sign-on processes and information may include location of the application, launching of the application, type of credential needed to access and use the application, user interfaces for obtaining credentials from a user (e.g., a first time user may be prompted to provide credentials when attempting to access the application), and providing the credentials during the sign-on process.

According to an exemplary embodiment, user access provisioning device 110 may allow users to perform other provisioning and configurations pertaining to the sign-on system, in view of user roles, as previously described. Additionally, according to an exemplary embodiment, user access provisioning device 110 may also allows users to offer their feedback pertaining to the sign-on system. For example, a user may submit feedback forms. Also, the user may request that a site, a session, and/or an application be added to the sign-on system.

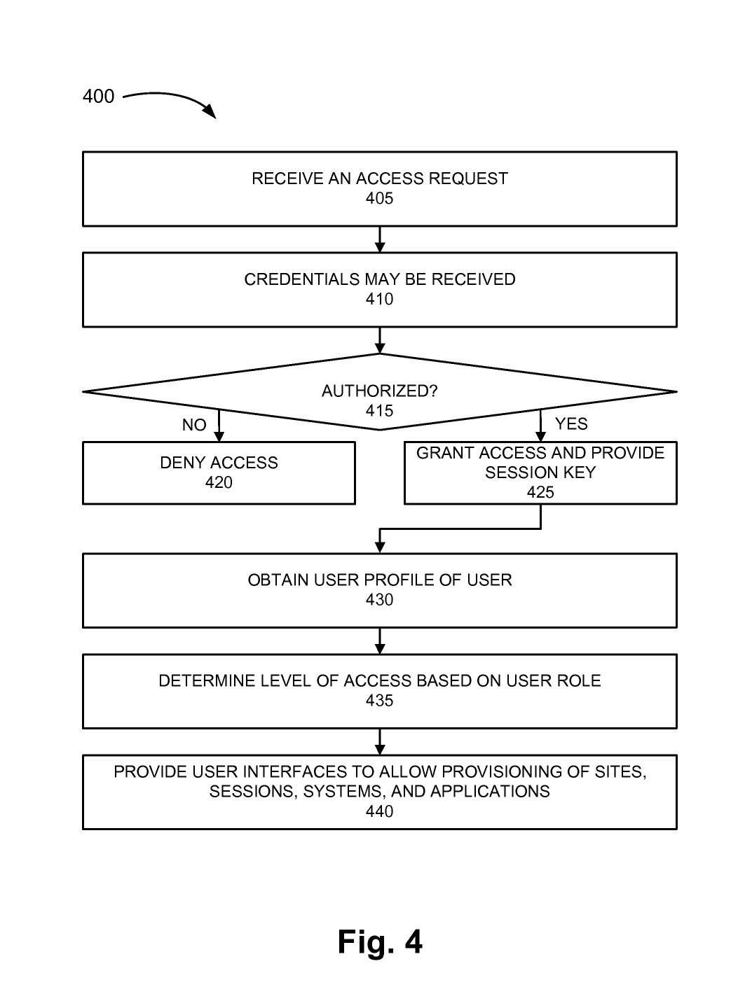

FIG. 4 is a flow diagram illustrating an exemplary process 400 for signing into and provisioning sites, sessions, and applications. According to an exemplary embodiment, one or more operations included in process 400 may be implemented by user access provisioning device 110.

An access request may be received (block 405). For example, user access provisioning device 110 may receive from a user, via user device 130, a request to access user access provisioning device 110.

Credentials may be received (block 410). For example, user access provisioning device 110 or SSO device 115 may receive sign-on credentials from the user, via user device 130.

It may be determined whether a user is authorized (block 415). For example, user access provisioning device 110 or SSO device 115 may determine whether the user is authorized to access and use user access provisioning device 110 based on the received credentials.

If it is determined that the user is not authorized (block 415—NO), the user may be denied access (block 420). If it is determined that the user is authorized (block 415—YES), access to the user access provisioning portal may be granted and a session key may be provided (block 425). The session key may include user access information, such as, for example, a user access provisioning device identifier, a level of access (e.g., user role), and a timestamp (e.g., date, time, etc.).

A user profile of the user may be obtained (block 430). For example, user access provisioning device 110 may obtain the user profile information of the user from database device 125.

A level of access based on the user profile may be determined (block 435). For example, user access provisioning device 110 may determine a level of access to grant the user based on the user profile information.

User interfaces to allow provisioning of sites, sessions, systems, and applications may be provided (block 440). For example, user access provisioning device 110 may provide user interfaces to allow the user to provision and configure automated sign-on services to sites, sessions, systems, and applications. As previously described, the user may provision and configure processes and information pertaining to SSO protected sites, non-SSO protected sites, mainframe sessions and applications, systems (e.g., network devices, user devices, etc.), and other types of applications (e.g., desktop applications, Windows Forms-based applications, LOB applications (e.g., department-based applications, company-based applications, etc.), common applications (e.g., applications available to all LOBs, applications available to all users, etc.)).

Although FIG. 4 illustrates an exemplary process 400, according to other embodiments, process 400 may include additional operations, fewer operations, and/or different operations than those illustrated in FIG. 4 and described. Additionally, or alternatively, according to other embodiments, one or more operations described as being performed by a particular device, may be performed by a different device or a combination of devices.

The foregoing description of implementations provides illustration, but is not intended to be exhaustive or to limit the implementations to the precise form disclosed. Accordingly, modifications to the implementations described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while a series of blocks have been described with regard to the process illustrated in FIG. 4, the order of the blocks may be modified in other implementations. Further, non-dependent blocks may be performed in parallel. Additionally, with respect to other processes described in this description, the order of operations may be different according to other implementations, and/or operations may be performed in parallel.

The embodiments described herein may be implemented in many different forms of software and/or firmware executed by hardware. For example, a process or a function may be implemented as “logic” or as a “component.” The logic or the component may include, for example, hardware (e.g., processing system 205, etc.), a combination of hardware and software (e.g., applications 215), a combination of hardware and firmware, or a combination of hardware, software, and firmware. The implementation of software or firmware has been described without reference to the specific software code since software can be designed to implement the embodiments based on the description herein. Additionally, a computer-readable medium may store instructions, which when executed, may perform processes and/or functions pertaining to the exemplary embodiments described herein.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

No element, act, operation, or instruction described in the present application should be construed as critical or essential to the embodiments described herein unless explicitly described as such.

What is claimed is:

1. A method comprising:
receiving an access request to a provisioning system;
determining whether to grant access based on receipt of one or more user credentials included in the access request;
determining a level of access to the provisioning system based on user role information, when the one or more user credentials are valid;
receiving configuration information by the provisioning system that permits a user to configure an automated sign-on system for single sign-on sites, non-single sign-on sites, mainframe sessions, mainframe applications, systems, and user device applications; and
configuring the automated sign-on system based on the received configuration information.

2. The method of claim 1, further comprising:
providing user interfaces to allow for testing and development of one or more processes pertaining to the automated sign-on system.

3. The method of claim 1, wherein the configuration information includes a network address associated with a non-single sign-on site or a single sign-on site, information pertaining to finding one or more credential fields associated with the non-single sign-on site or the single sign-on site, information pertaining to populating the one or more credential fields associated with the non-single sign-on site or the single sign-on site, and information pertaining to submitting the one or more credentials to the non-single sign-on site or the single sign-on site, and the method further comprising:
configuring an automated sign-on to the non-single sign on site or the single sign-on site based on the configuration information.

4. The method of claim 1, wherein the configuration information includes information pertaining to a type of connection between a user device and a mainframe device, information pertaining to an automation of establishing a connection between the user device and the mainframe device, information pertaining to populating one or more credential fields, information pertaining to a location of a mainframe application, and information pertaining to a launching of the mainframe application, and the method further comprising:
configuring an automated sign-on to a mainframe session or the mainframe application based on the configuration information.

5. The method of claim 1, wherein the configuration information includes information pertaining to a location of a user device application, information pertaining to a type of user credential, information pertaining to populating one or more credential fields, and information pertaining to a launching of the user device application, and the method further comprising:
configuring an automated sign-on to the user device application based on the configuration information.

6. The method of claim 1, wherein the configuration information includes a creation, a modification, or a deletion of a group of users that are assigned a shared user credential pertaining to an automated sign-on process of at least one of a single sign-on site, a non-single sign-on site, a mainframe session, a system, or a user device application.

7. The method of claim 1, wherein the configuration information includes an assignment of at least two of a single sign-on site, a non-single sign-on site, a mainframe session, a system, or a user device application with a user or a group of users, and an assignment of a shared user credential to allow the automated sign-on to the at least two of the single sign-on site, the non-single sign-on site, the mainframe session, the system, or the user device application.

8. The method of claim 1, further comprising:
providing log information that includes information pertaining to users access and use of the single sign-on sites, the non-single sign-on sites, the mainframe sessions and applications, the system, and the user device applications.

9. A network device comprising logic to:
receive an access request that includes one or more user credentials;
determine whether to grant access based on the one or more user credentials;
determine a level of access, when the one or more user credentials are valid, wherein the level of access corresponds to a level of configuration privileges;
receive configuration information that permits a user to configure an automated sign-on for single sign-on sites, non-single sign-on sites, mainframe sessions and mainframe applications, systems, and user device applications; and
configure the automated sign-on based on the received configuration information.

10. The network device of claim 9, wherein the configuration information includes a creation, a modification, or a deletion of a group of users having a shared credential for accessing and using a single sign-on site and at least one of a non-single sign-on site, a mainframe session, a system, or a user device application, and the logic is further configured to:
configure the creation, the modification, or the deletion of the group of users based on the configuration information.

11. The network device of claim 9, comprising logic to:
provide user interfaces to allow for testing and development of one or more processes that provide for an automated sign-on to a single sign-on site, a non-single sign-on site, a mainframe session, a mainframe application, a system, and a user device application.

12. The network device of claim 9, wherein the configuration information includes a network address associated with a non-single sign-on site or a single sign-on site, information pertaining to finding one or more credential fields associated with the non-single sign-on site or the single sign-on site, information pertaining to populating the one or more credential fields associated with the non-single sign-on site or the single sign-on site, and information pertaining to submitting the one or more credentials to the non-single sign-on site or the single sign-on site, and the logic is further configured to:
configure an automated sign-on process to the non-single sign-on site or the single sign-on site based on the configuration information.

13. The network device of claim 9, wherein the configuration information includes information pertaining to a type of connection between a user device and a mainframe device, information pertaining to an automation of establishing a connection between the user device and the mainframe device, information pertaining to populating one or more credential fields, information pertaining to a location of a mainframe application, and information pertaining to a launching of the mainframe application, and the logic is further configured to:
configure an automated sign-on process to the mainframe session or the mainframe application based on the configuration information.

14. The network device of claim 9, wherein the configuration information includes information pertaining to a location of the user device application, information pertaining to a type of user credential, information pertaining to populating one or more credential fields, and information pertaining to a launching of the user device application, and the logic is further configured to:
configure an automated sign-on process to the user device application based on the configuration information.

15. The network device of claim 9, wherein the user device applications include Windows Forms applications, desktop applications, line-of-business applications, and common applications.

16. The network device of claim 9, wherein the network device comprises a web server.

17. One or more computer-readable mediums comprising executable instructions for execution by at least one processing system, the instructions causing the at least one processing system to:
receive an access request that includes one or more user credentials;
determine whether to grant access based on the one or more user credentials;
determine a level of access, when the one or more user credentials are valid, wherein the level of access corresponds to a level of configuration privileges;
receive configuration information that permits a user to configure an automated sign-on for single sign-on sites, non-single sign-on sites, mainframe sessions and applications, and user device applications; and
configure the automated sign-on based on the received configuration information.

18. The one or more computer-readable mediums of claim 17, comprising instructions that further cause the at least one processing system to:
provide user interfaces to allow for testing and development of one or more processes that provide for an automated sign-on to a single sign-on site, a non-single sign-on site, a mainframe session, a mainframe application, a system, and a user device application.

19. The one or more computer-readable mediums of claim 17, wherein the configuration information includes a creation, a modification, or a deletion of a group of users having a shared credential for accessing and using a single sign-on site and at least one of a non-single sign-on site, a mainframe session, a system, or a user device application, and comprising instructions that further cause the at least one processing system to:
configure the creation, the modification, or the deletion of the group of users based on the configuration information.

20. The one or more computer-readable mediums of claim 17, comprising the instructions that further cause the at least one processing system to:
providing log information that includes information pertaining to users access and use of the single sign-on sites, the non-single sign-on sites, the mainframe sessions, the systems, and applications, and the user device applications.
